(19) United States
(12) Patent Application Publication
(10) Pub. No.: US 2022/0379635 A1
(43) Pub. Date: Dec. 1, 2022

(54) PRINTING FLUID DELIVERY SYSTEM

(71) Applicant: HEWLETT-PACKARD DEVELOPMENT COMPANY, L.P., Spring, TX (US)

(72) Inventors: Carrie E. Harris, Corvallis, OR (US); Robert S. Wickwire, Corvallis, OR (US)

(21) Appl. No.: 17/755,902

(22) PCT Filed: Nov. 22, 2019
(86) PCT No.: PCT/US2019/062738

§ 371 Date: May 11, 2022

(51) Int. Cl. B41J 11/42

(52) U.S. Cl. CPC B41J 11/42

(57) ABSTRACT

A recharge system can receive an indication of a saturation level of a porous media within a printhead and determine, based on the indication of the saturation level of the porous media, that the saturation level satisfies a threshold to initiate a recharge cycle. The threshold may be higher than a saturation level at which the porous media is in a hysteresis state. In response to the determination, the recharge system initiates a recharge cycle.

### BACKGROUND

Image forming devices and systems may include printheads that are filled with a printing fluid and form images on a print medium. Some image forming devices may be refilled by providing additional printing fluid to a reservoir within the image forming device.

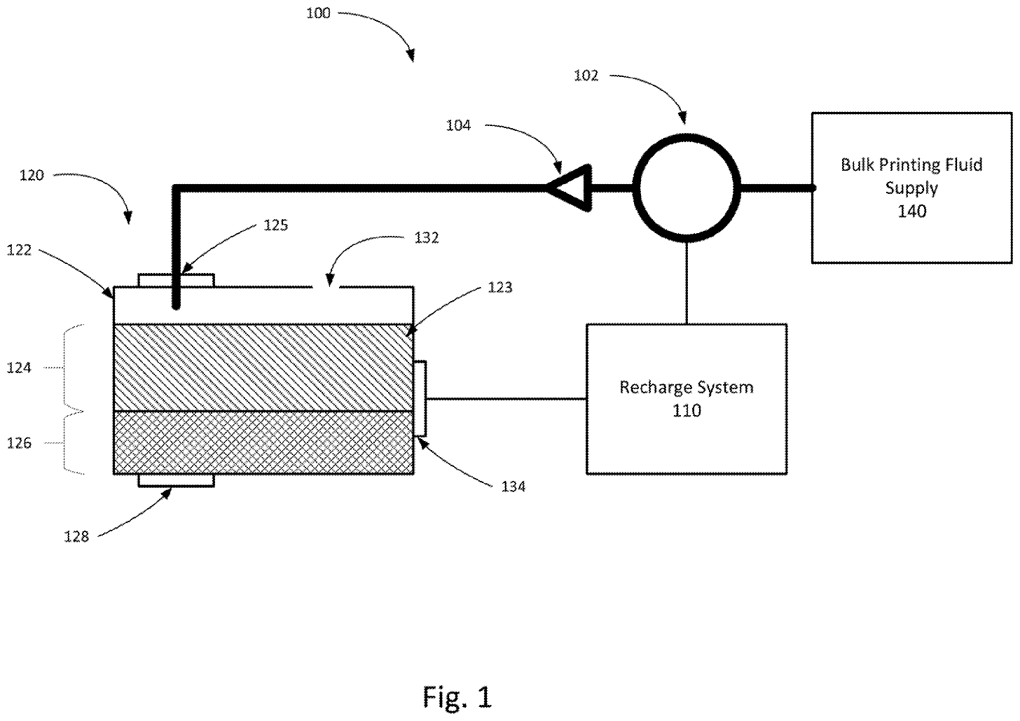

FIG. 1 is a block diagram illustrating example components of a printing system as described herein.

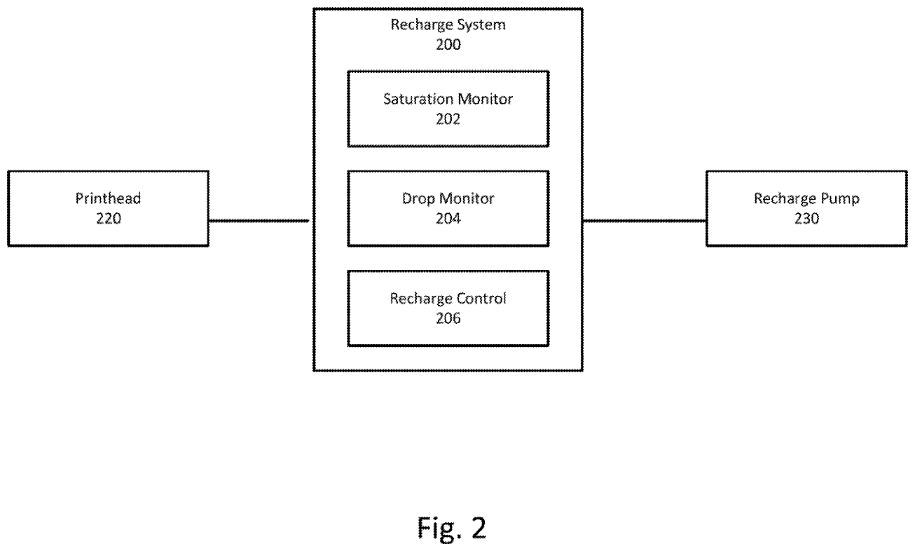

FIG. 2 is a block diagram illustrating example components of a recharging system as described herein.

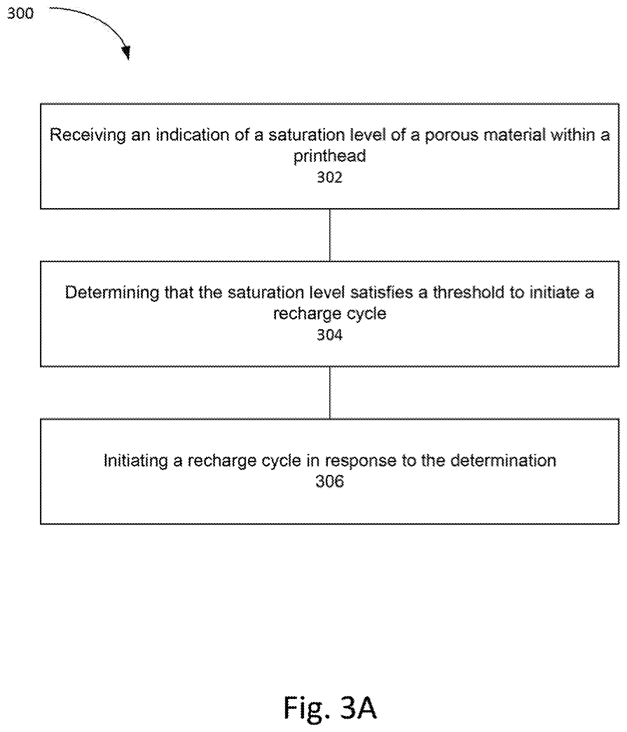

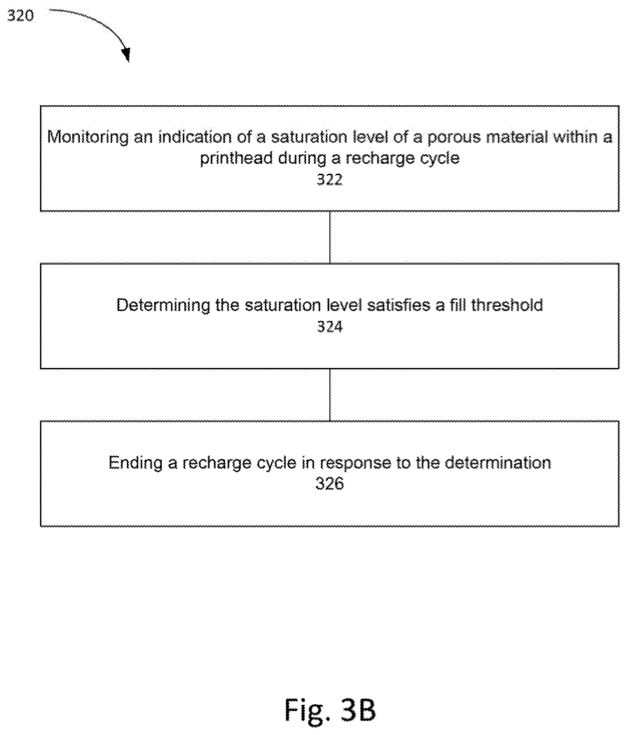

FIG. 3A is a flow chart illustrating an example method to performing recharging of a printhead as described herein.

FIG. 3B is a flow chart illustrating an example method to performing recharging of a printhead as described herein

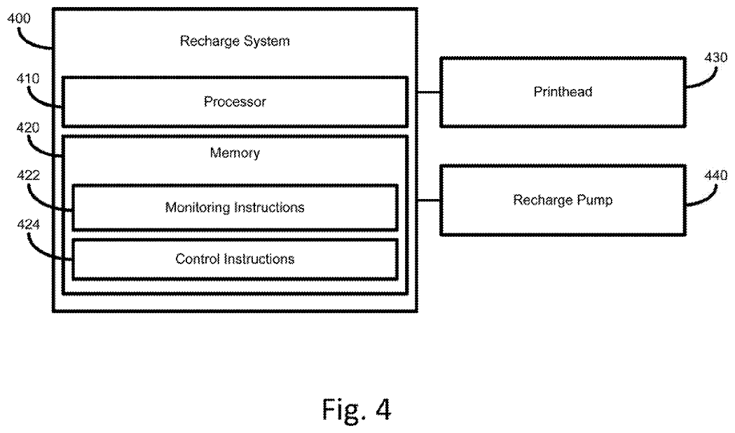

FIG. 4 is a block diagram illustrating example components of a recharge system as described herein.

### DETAILED DESCRIPTION

Described herein are inkjet printing systems that incorporate a set of porous media inkjet pens to supply printing fluid to print dies which eject printing fluid onto print media. The inkjet pens have a capacity that is less than the expected lifetime throughput of the printhead, therefore, the inkjet pens are refilled to continue printing. The systems described herein periodically recharge the volume of printing fluid within the inkjet pens from a bulk printing fluid supply to enable printing beyond the capacity of the inkjet pens.

This type of printing system is sometimes referred to as a continuous ink supply system (CISS for short), which can provide extended printhead lifetime that is not limited by the size of an associated pen. In some examples, an internal reservoir of the printing system is used to provide printing fluid to the inkjet pen to provide a continuous supply of printing fluid to the print dies. Furthermore, the internal reservoir may be refilled from an external bulk printing fluid supply. Of course, in various systems there may be additional intermediate reservoirs, or an external supply may be directly feeding into an inkjet pen.

In some CISS systems, the porous media inkjet pen may be refilled with a deep cycle refilling scheme. For example, the inkjet pen may be refilled with it reaches a low or minimum volume state and the refill may continue until the volume is brought to a high or maximum volume state. However, this can case the porous media to behave with hysteresis characteristics that affect the amount of printing fluid that is absorbed. Accordingly, the porous media may absorb less and less printing fluid with additional recharge cycles. Ultimately, this limits the life of the system as the absorption qualities of the porous media reach unacceptable levels.

The negative affects to the absorption of porous media used may affect the occur in several ways. For example, porous media such as polyurethane foams are normally hydrophobic so that the capillary structure must be wetted to absorb water-based fluids like printing fluids. The volume of wetted capillary, known as “wetband,” dictates the volume of fluid the media will imbibe. In systems that are deep-cycled, portions of the media are periodically kept in a low saturation state. This can lead to a shrinking of the wetband volume by drying.

A second way that deep-cycled porous media can experience a reduction in the ability to absorb printing fluid is if the media is poisoned with air. As the area of the porous media near the print die becomes desaturated it additional pressure is used to pull printing fluid out of the porous media and eject printing fluid. If the saturation level is reduced beyond a threshold, the additional pressure to pull printing fluid out of the porous media can exceed the bubble pressure of the media and air will be pulled into the porous media causing a low resistance path that will pull air through the porous media rather than printing fluid out of the capillaries. Both drying of the porous media and poisoning the porous media with air can be irreversible situations within the inkjet pen.

In addition to over-drying of the porous media, over-saturation of the porous media can also lead to operation issues for the printing device. For example, if the porous media is oversaturated, the back pressure provided by the capillary action of the porous media may not overcome the downward pressure of the printing fluid on a print die. This can lead to leaking of printing fluid creating a mess for a user or operation problems of print media handling due to overly wet print media.

Accordingly, systems and methods disclosed herein utilize a recharge scheme that avoids deep-cycling of a porous media in order to provide longer lifetime operation of printheads and avoid potential print defects or spillage due to compromised porous media. The recharge scheme may use measurements of porous media saturation to determine when the porous media is in a non-hysteresis portion of the porous media's saturation curve. The system can then recharge the pen when the saturation approaches the lower end of the non-hysteresis portion of the saturation curve as printing fluid is ejected by the print die. The system can then recharge the pen until it is near a higher end of the non-hysteresis portion of the saturation curve. The range of cycling can then be used repeatedly without reducing the absorption ability of the porous media.

In some examples, the saturation of a porous media may be continuously monitored by a dedicated recharge system within an inkjet printing system. For example, the recharge system may include a sensor associated with a printing fluid pen that provides an indication of the saturation of the pen. In response to the current saturation of the pen, the recharge system may turn a pump on or off that provides printing fluid to the pen. For example, the recharge system may trigger a pump to turn on or off in response to reaching a low or high threshold of saturation within the porous media. The pump may be independent and generate drops of printing fluid that are provided to the top of porous media in the pen.

In some examples, the recharge system may monitor the saturation of a porous media in response to triggering events. For example, the recharge system may measure saturation of the porous media at the conclusion of a print job when a user is less likely to have an immediate use of the printing device. In some examples, drop counting of ejected printing fluid may be performed after a recharge event of the pen. The recharge system may then operate a sensor to determine a saturation level of the porous media. Based on the saturation level, the recharge system may initiate a recharge action.

In some examples, there is a dedicated pump with its own actuation for the recharge system as discussed above. However, in some examples, the pump may share a drive mechanism with other components of a printing device. Therefore, in certain examples, a transmission changes the drive mechanism from another printing system to the recharge system in order to recharge a pen. In such examples, the recharge system may not operate at the same time as other components of the printing system. Accordingly, periodic monitoring based on drop counting of ejected printing fluid may improve operation of the recharge system.

Printing systems as used herein may include printers, copiers, fax machines, multifunction devices including additional scanning, copying, and finishing functions, all-in-one devices, pad printers to print images on three dimensional objects, and three-dimensional printers (additive manufacturing devices). Furthermore, print media may be used herein to describe plain paper or other suitable media or objects such as inflexible media, textiles, bulk objects, boxes, powdered build materials (for forming three-dimensional articles), or other suitable substrates. Printing fluids, including printing agents and colorants, may include ink, fusing agents, detailing agents, or other materials that may be applied to a substrate with print die that includes a nozzle that utilizes a maintenance printing fluid scheduling system to provide consistent operation of a print die. For example, thermal inkjet printhead, piezo inkjet printheads, or other printheads that eject printing fluids to a print media may be operated according to example systems and methods as described herein.

FIG. 1 is a block diagram illustrating example components of a printing system 100 as described herein. The printing system 100 includes a bulk printing fluid supply 140, a recharge system 110, and a fluidic device 120. The recharge system controls a pump 102 that when actuated moves printing fluid from bulk printing fluid supply 140 through a valve 104 into a pen 122 of the fluidic device 120.

The components of an image forming device shown in FIG. 1 are a subset of components of a complete image forming device. In various examples the image forming device may include media handling components, media storage components, scanning components, output trays, or additional components to complete an image forming device. In some examples, the components shown may be incorporated into larger systems, such as three-dimensional printing systems, solid media printing (e.g., corrugated cardboard or the like), or other media printing, that utilize printing fluid ejection through a printhead having a porous media pen.

The bulk printing fluid supply 140 may be a refillable printing fluid tank or replaceable cartridge that is used to introduce additional printing fluid into the printing system. In some examples, the bulk supply must have a vent such as a spring-loaded normally closed valve or non-wetting membrane that keeps printing fluid in when the printer is tipped or inverted. Accordingly as the bulk printing fluid supply 140 is depleted, the valve allows air to pass into the supply to replace printing fluid used by the system. The bulk printing fluid supply 140 is coupled to the pump 102 by way of a fluidic channel.

The pump 102 may be a multi-channel (one for each color printing fluid) positive displacement pump that can move a mix of fluids at system pressures including air, printing fluid, a mixture of air and printing fluid, froth, or other fluidic mixture. For example, based on agitation of the bulk printing fluid supply or introduction of air into the bulk printing fluid supply 140, the fluid may develop into a froth or other mix of air and fluid. Accordingly, the pump 102 is designed to pass a variety of mixtures from the bulk printing fluid supply 140

The valve 104 may be a normally closed valve that opens during a top-off or recharge cycle. This fluidically isolates the pen 122 from the bulk printing fluid supply. Accordingly, the valve 104 can prevent the back flow of fluid in various altitudes and temperature changes or tipping incidents that may occur during shipping, installation, or the like.

During a recharge operation, a fluid interconnect 125 connects the output of the pump 102 to fill the pen 122 of the fluidic device 120 in order to maintain saturation of a porous media 123. In some examples, the exit of the fluid interconnect 125 is positioned above the porous media 123 in order to avoid introducing air into the porous media 123 and thereby risking air poisoning of the system. A vent 132 is positioned above the porous media 123 as well to allow the release of air that is entered into the system either during a fill or recharge operation. In some examples, the pen 122 is vented thru a labyrinth to allow air to escape the pen 122 while also reducing water vapor loss from the porous media 123.

The fluidic device 120 includes the porous media 123 and the print die 128 which includes nozzles for ejecting printing fluid onto a print media. The porous media 123 contains a small on-board volume of fluid for printing. The composition of the porous media 123 provides backpressure to prevent leaks and protect the against tipping, altitude, and environmental changes.

In some examples, the porous media 123 has different characteristics at various levels of saturation. Furthermore, if the saturation if above or below certain levels, negative consequences of the saturation level may reduce the print quality or lifespan of the fluidic device 120. Accordingly, as described herein the recharge system 110 operates the pump 102 to maintain an appropriate saturation level for the porous media 123. Furthermore, as shown, there may be different levels of saturation in different portions of the porous media 123. For example, an upper portion 124 of the porous media 123 may have less saturation than a lower portion 126 of the porous media. In some examples, of course, the saturation level may be at a gradient throughout the porous media 123.

A sensor 134 measures the saturation of the porous media 123. For example, the sensor 134 may be a set of electrodes that measure the resistance between the electrodes to determine an approximate saturation. In some examples, there may be a number of sensors 134 having multiple electrodes that are placed about the pen 122 to measure an approximate saturation within the porous media 123. In some examples, the sensors 134 are placed in a manner to measure the saturation at areas of particular interest within the porous media 123. For example, there may be sensors at the top and bottom of the porous media 123 to measure approximate high and low values of the saturation of the porous media 123 within the pen 122. The sensors 134 may then be coupled to the recharge system 110. The recharge system 110 can use one or more measurements to best ensure that the saturation of the porous media 123 is within an operational range.

The recharge system 110 includes components to monitor saturation of the porous media 123 and determine when to actuate pump 102. The recharge system determines when the porous media is not full of printing fluid enabling a recharge and during the recharge cycle determines when the porous media reaches a filled saturation and ends the recharge cycle. For example, the recharge system may determine when a saturation level is below 80% of initial fill to trigger a recharge operation and may determine when the saturation is over 90% to end a recharge operation. In various examples, the recharge system 110 may use different saturation ranges based on the characteristics of the porous media 123 and the fluid from the bulk printing fluid supply 140.

FIG. 2 is a block diagram illustrating additional details of a recharging system 200 as described herein. For example, the recharging system 200 may be the same or similar to the recharge system 110 described above with reference to FIG. 1. As shown in FIG. 2, the recharge system 200 communicates with the printhead 220 and the recharge pump 230. The recharge system 200 may receive sensor information from the printhead 220, analyze that information, and use the analysis to control the recharge pump 230.

In some examples, the recharge system 200 includes a saturation monitor 202, a drop monitor 204, and recharge control 206. In various implementations, the recharge system 200 may include fewer or additional components or those components may be split or combined into other components. For example, the recharge system 200 may operate without a drop monitor 204 as discussed further below.

The printhead 220 may be the same or similar as the fluidic device 120 described with reference to FIG. 1. For example, printhead 220 may include a pen containing a porous media for holding printing fluid that is then ejected from one or more nozzles. The printhead 220 also includes a sensor that generates an indication of a saturation level of the porous media that is provided to the recharge system 220. Based on the saturation level, the recharge system may turn a recharge pump 230 on, turn the recharge pump 230 off, or continue a current state of the recharge pump 230.

In some examples, the recharge system 200 is a stand-alone component of a printing device with components, such as recharge pump 230 acting for continuous use by the recharge system. In some examples, to save space or expense, the recharge system 200 may have some features shared by other components of a printing system. For example, the recharge pump 230 may be actuated by the same motor that is used for a media path, a service system, or another component of a printing system and may be actuated by a clutch that activates the recharge pump 230. Accordingly, depending on the example, various features of the recharge system 200 may be used a certain times but not at others. Notably, this may affect the timing of measurements or determinations made by the recharge system 200 as discussed further below.

As shown, recharge system 200 includes a saturation monitor 202, a drop monitor 204, and recharge control 206. The saturation monitor 202 determines a saturation level of the porous material based on sensor readings. In some examples, the saturation level may be provided from the printhead directly based on sensor readings or raw signals may be provided to the saturation monitor 202 for interpretation by the recharge system 200. In some examples, a baseline sensor reading is determined for an initial fill of the printhead 220 and the saturation monitor 202 determines a relative sensor reading to mark as a threshold level to trigger an event. The saturation monitor 202 may periodically monitor the saturation level of the printhead 220 for each of the colors or types of printing fluid.

The saturation monitor 202 may then provide a saturation reading to the recharge control 206 to determine whether to initiate a recharge event. In some examples, such as when the recharge system 200 and recharge pump 230 are a standalone unit, the saturation monitor 202 may operate continuously to determine a saturation level for the printheads 220. The recharge system 200 may then determine whether to initiate a recharge event at any time. In some examples, the saturation monitor 202 may operate periodically based on other events of a printing system. For example, the saturation monitor 202 may be triggered in response to a page of printing being completed, a print job being completed, or another event within a printing system.

In some examples, the saturation monitor 202 is triggered based on a drop count received from drop monitor 204. For example, the drop monitor 204 can determine drops that are ejected from the nozzles within the printhead 220. Based on readouts from the drop monitor 204, the recharge system 200 can predict an amount of depletion of the printhead 220. When the predicted amount of saturation depletion occurs from the printhead 220, the recharge system 200 can cause the saturation monitor 202 to take a saturation reading from the printhead 220. In some examples, the saturation monitor 202 can be triggered independently for each of the printheads 220. In some examples, the saturation monitor 202 may take a reading for a printhead 220 that is predicted to be nearing a depletion state, but not other printheads.

The recharge system 200 may trigger the saturation monitor 202 before the predicted level reaches a state that is in a hysteresis saturation state. For example, if the porous media of the printhead 220 operates in a non-hysteresis saturation state between 80% and 90% saturation, the saturation monitor 202 may begin monitoring the saturation state of the porous media when it reaching 82% saturation to avoid reaching a depleted state. In some examples, the saturation monitor 202 may be triggered in response to a combination of events, such as the end of a page, the end of a job, a drop count and estimated saturation levels, other printing system events, a set time period, or a combination of events available to the recharge system 200.

The recharge control 206 instructs a recharge pump 230 to pump fluid from a bulk printing fluid supply to a printhead 220. For example, the pump 230 and fluidic channels may operate as discussed with respect to FIG. 1 above. The recharge control 206 may have a set of saturation levels associated with each of the printheads 220 at which to initiate a recharge cycle. In some examples, the saturation levels may be the same for each printhead 220 based on the properties of the porous media and printing fluid.

In addition to the particular saturation level of a printhead, the recharge control 206 may access additional parameters of a print job to determine when to initiate, a recharge cycle. For example, if a print job is monochromatic or nearing completion, the recharge control 206 may wait until closer to a depleted saturation state before initiating a recharge cycle. In some examples, the recharge control 206 may initiate a recharge cycle with a buffer based on the saturation level of the porous media. For example, the recharge control 206 may initiate a recharge cycle at several percentages of saturation level before entering a hysteresis state. The buffer may also be used to wait to initiate a recharge cycle until a convenient time such as the end of a page as discussed above.

In addition to initiating a recharge cycle, the recharge control 206 determines when to end a recharge cycle. If the printhead is oversaturated, it may cause spillage, leaks, or reduced print quality by the printhead. For example, the printhead may not maintain capillary pressure from the porous media if the media becomes oversaturated. Accordingly, the recharge control 206 may prevent oversaturation of the porous media by receiving continued signals from the saturation monitor 202. In some examples, the recharge control 206 may activate a recharge pump 230 for a set period of time with an assumption that a predictable range of fluid will be transferred to the printhead 220. In response to determining that the saturation level satisfies an upper threshold, the recharge control 206 instructs the recharge pump 230 to deactivate and end the recharge cycle.

FIG. 3A is a flow chart illustrating an example method 300 to performing recharging of a printhead as described herein. For example, the method may be performed by the components of systems as described with reference to FIGS. 1 and 2. In various examples, the processes described in reference to flow diagram 300 may be performed in a different order or the method may include fewer or additional blocks than are shown in FIG. 3A.

Beginning in block 302, a recharge system receives an indication of a saturation level of a porous media within a printhead. For example, the indication may be received from a sensor attached to a printhead, such as a set of electrodes, or other types of sensors. The saturation level may be determined as a percentage of saturation relative to a maximum fill level, as an amount of printing fluid that is present, or as another indication of saturation. The indication of the saturation level may be received continuously, periodically, or in response to specific events of a printing device. For example, the sensor may send a signal in response to a set number of drops that have been emitted by a printhead that indicate a predictable amount of printing fluid has been emitted. In some examples, a sensor reading may be taken in response to completion of a page of a print job, an entire print job, an amount of idle time, or another event.

In block 304 the recharge system determines that the saturation level satisfies a threshold to initiate a recharge cycle. For example, the recharge system may have a set of saturation values at which to trigger a recharge cycle. In some examples, the saturation values may be directly correlated to a sensor reading, or they may be calculated based on the sensor reading. The threshold may be predetermined based on properties of the porous media and the printing fluid so that the recharge is started before the porous media enters a non-hysteresis saturation state. In some examples, this state may be 70%, 80%, 85%, 90% or another saturation level compared to a saturated porous media. In order to ensure the porous media does not enter the hysteresis state, the threshold may be set above the hysteresis saturation state.

In block 306, the recharge system initiates a recharge cycle in response to determining that the saturation level of the porous media is below the threshold. For example, the recharge system may actuate a recharge pump that couples a bulk printing fluid supply to the printhead. The recharge pump can then supply printing fluid to the printhead while the sensor continues to provide an indication of saturation. When the saturation level reaches a predetermined fill level (which may be less than 100% saturation), the recharge system ends the recharge cycle. In some examples, rather than continuously monitoring the printhead, the amount of printing fluid provided to the printhead may be monitored to achieve an approximate desired saturation. While not limiting, the amount of printing fluid provided to certain printheads may be approximately 0.1-0.2 cc of fluid. The recharge pump may achieve this in approximately 2 seconds in some examples. The amount of time and fluid will depend on the size of the printhead, the type of porous media, the printing fluid that is used.

FIG. 3B is a flow chart illustrating an example method 320 to determine when a recharge cycle is complete and end the cycle. For example, the method may be performed by the components of systems as described with reference to FIGS. 1 and 2. In various examples, the processes described in reference to flow diagram 320 may be performed in a different order or the method may include fewer or additional blocks than are shown in FIG. 3B.

The example method 320 may be performed after the example method 300 described above to determine when to deactivate a pump to complete the recharge cycle. Beginning in block 322, the recharge system monitors the saturation level of the porous material during the recharge cycle. For example, the recharge system can monitor an indication received from a sensor attached to the printhead, such as a set of electrodes, or other types of sensors. The saturation level may be determined as a percentage of saturation relative to a maximum fill level, as an amount of printing fluid that is present, or as another indication of saturation. The indication of the saturation level may be received continuously, periodically, or in response to specific events, such as an amount of time that the recharge pump has been active.

In block 324, the recharge system determines that the saturation level satisfies a fill threshold. For example, the fill threshold may be a set threshold at which the porous material is within the non-hysteresis saturation state, but below a fill level that would reduce back-pressure to cause drool from the printhead or leaking from the pen. In some examples, the saturation values may be directly correlated to a sensor reading, or they may be calculated based on the sensor reading. The threshold may be predetermined based on properties of the porous media and the printing fluid so that the recharge is ended before the porous media is oversaturated. In some examples, this state may be 70%, 80%, 85%, 90%, 95%, or up to 100% of a maximum saturation of a porous media.

In block 326, the recharge system ends the recharge cycle in response to determining that the saturation level satisfies the fill threshold. For example, the recharge system may stop actuating a recharge pump that couples a bulk printing fluid supply to the printhead. In examples wherein the recharge pump is activated by a common motor that provides drive to other components of the printing system, a clutch may provide the motor functionality back to other components.

FIG. 4 is a block diagram illustrating an example recharge system 400 of an image forming device as described herein, recharge system 400 may include at least one computing device that is capable of communicating with at least one remote system. In the example of FIG. 4, recharge system 400 includes a processor 410 and a memory 420. Although the following descriptions refer to a single processor and a single computer-readable medium, the descriptions may also apply to a system with multiple processors and computer-readable mediums. In such examples, the instructions may be distributed (e.g., stored) across multiple computer-readable mediums and the instructions may be distributed (e.g., executed by) across multiple processors.

Processor 410 may be a central processing unit (CPUs), a microprocessor, and/or other hardware devices suitable for retrieval and execution of instructions stored in memory 420. In the example recharge system 400, processor 400 may receive, determine, and send monitoring instructions 422 and control instructions 424 to generate print fluid supply for a printhead of an image forming device. As an alternative or in addition to retrieving and executing instructions, processor 410 may include an electronic circuit comprising a number of electronic components for performing the functionality of an instruction in memory 420. With respect to the executable instruction representations (e.g., boxes) described and shown herein, it should be understood that part or all of the executable instructions and/or electronic circuits included within a particular box and/or may be included in a different box shown in the figures or in a different box not shown.

Memory 420 may be any electronic, magnetic, optical, or other physical storage device that stores executable instructions. Thus, memory 420 may be, for example, Random Access Memory (RAM), an Electrically-Erasable Programmable Read-Only Memory (EEPROM), a storage drive, an optical disc, and the like. Memory may be disposed within recharge system, as shown in FIGS. 1 and 2. In this situation, the executable instructions may be “installed” on the system 400.

Monitoring instructions 422 stored on memory 420 may, when executed by the processor 410, cause the processor 410 to monitor printhead 430. For example, as discussed above, the recharge system 400 may monitor saturation of a porous media of printhead 430 to determine when to initiate a recharge cycle. Based on the results of monitoring by the recharge system 400, the control instructions 424 may cause the processor 410 to determine when to initiate a recharge cycle of printhead 430 by actuating a recharge pump 440. In addition to the operations discussed, memory 420 may include additional instructions that enable additional systems and operations as described herein. For example, those processes described with respect to FIGS. 1-3 may be performed based on instructions stored on memory 420 or executed by processor 410 as described with reference to recharge system 400.

It will be appreciated that examples described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. In various examples other non-transitory computer-readable storage medium may be used to store instructions for implementation by processors as described herein. Accordingly, some examples provide a program comprising code for implementing a system or method as claimed in any preceding claim and a machine-readable storage storing such a program.

The features disclosed in this specification (including any accompanying claims, abstract and drawings), and/or the operations or processes of any method or process so disclosed, may be combined in any combination, except combinations where at least some of such features and/or processes are mutually exclusive.

Each feature disclosed in this specification (including any accompanying claims, abstract, and drawings), may be replaced by alternative features serving the same, equivalent or similar purpose, unless expressly stated otherwise. Thus, unless expressly stated otherwise, each feature disclosed is an example of a generic series of equivalent or similar features.

1. A method comprising:
receiving an indication of a saturation level of a porous media within a printhead;
determining, based on the indication of the saturation level of the porous media, that the saturation level satisfies a threshold to initiate a recharge cycle; and
initiating the recharge cycle,
wherein, the threshold is higher than a saturation level at which the porous media is in a hysteresis state.

2. The method of claim 1, further comprising:
monitoring the saturation level of the porous material during the recharge cycle; and
ending the recharge cycle in response to determining that the saturation level satisfies a second threshold.

3. The method of claim 1, wherein initiating the recharge cycle comprises trigging a pump to transfer printing fluid from a bulk printing fluid supply to the printhead.

4. The method of claim 1, further comprising predicting a saturation level of the porous media based on a drop count of the printhead.

5. The method of claim 4, wherein receiving the indication of the saturation level is initiated in response to a prediction of saturation approaching the threshold.

6. The method of claim 1, wherein receiving the indication of the saturation level comprises receiving a signal from a sensor coupled to the printhead.

7. The method of claim 1, wherein receiving the indication of the saturation level is initiated in response to a printing event of a printing device.

8. A recharge system of an image forming device, comprising:
a memory to store a set of instructions; and
a processor to execute the set of instructions to:
monitor a printhead to determine that a saturation level of the printhead satisfies a threshold to avoid operating depletion to a hysteresis state; and
initiate a recharge cycle of the printhead in response to avoid entering the hysteresis state.

9. The recharge system of claim 8, wherein the processor is further to:
monitoring the saturation level of the porous material during the recharge process; and
ending the recharge cycle in response to determining that the saturation level satisfies a second threshold.

10. The recharge system of claim 8 further comprising a recharge pump activated during the recharge cycle to to transfer printing fluid from a bulk printing fluid supply to the printhead.

11. The recharge system of claim 8, wherein the processor is further to predict a saturation level of the porous media based on a drop count of the printhead.

12. The recharge system of claim 8, further comprising a sensor to generate a signal used by the processor to determine the saturation level of the porous media.

13. The recharge system of claim 8, wherein the processor is further to determine the saturation level is initiated in response to a printing event of a printing device.

14. A non-transitory computer-readable storage medium comprising a set of instructions executable by a processor to:
receive an indication of a saturation level of a porous material within a printhead;
determine, based on the indication of the saturation level of the porous material, that the saturation level satisfies a first threshold to initiate a recharge cycle;
initiate the recharge cycle,
monitor the saturation level of the porous material during the recharge cycle; and
end the recharge cycle in response to determining that the saturation level satisfies a second threshold,
wherein, the first threshold is higher than a saturation level at which the porous material is in a hysteresis state.

15. The non-transitory computer-readable storage medium of claim 14, wherein the instructions set the first threshold to between 75% and 85% and the second threshold to between 90% and 95%.
